(19) United States
(12) Patent Application Publication
(10) Pub. No.: US 2020/0410560 A1
(43) Pub. Date: Dec. 31, 2020

(54) Prefilled Owner Invoices

(71) Applicant: Procore Technologies, Inc., Carpinteria, CA (US)

(72) Inventors: Jeanine Chiu, Jamaica Plain, MA (US); Gabe Harms, Carpinteria, CA (US); Connor McCormick, Santa Barbara, CA (US)

(21) Appl. No.: 16/453,433

(22) Filed: Jun. 26, 2019

(51) Int. Cl. G06Q 30/04; G06F 17/24; G06Q 50/18; G06Q 50/08

(52) U.S. Cl. CPC G06Q 30/04; G06Q 50/08; G06Q 50/188; G06F 17/243

(57) ABSTRACT

An example computing system receives a prime contract schedule of values (SOV) including a plurality of line items, each having an associated project code and contract amount. The computing system also receives sub invoices including at least one sub invoice line item, each sub invoice line item having an associated cost code and sub invoice amount. The computing device matches the cost code from each sub invoice line item to a corresponding project code in one of the plurality of line items in the prime contract SOV such that each sub invoice line item corresponds to one of the plurality of line items in the prime contract SOV. Based on the matching, the computing device generates a prefilled owner invoice such that the sub invoice amount from each respective sub invoice line item is applied to the contract amount from the corresponding line item in the prime contract SOV.

### BACKGROUND

Construction projects can be massive endeavors involving multiple different parties. For example, there may be an owner who is funding the project, a general contractor (“GC”) who manages the overall construction project, and numerous subcontractors who provide labor and materials to the GC to build the project. Typically, there is a “prime contract” between the owner and the GC, outlining the GC's responsibilities for the project and the fees that the owner will pay to the GC. The GC, in turn, may enter into subcontracts with its subcontractors to complete portions of the construction project.

The prime contract between the owner and GC may reference construction specifications and drawings (e.g., architectural and engineering drawings), as well as a schedule of values (“SOV”) identifying how much the owner will pay the GC for each portion of the project. The SOV may include various cost codes associated with approved expenditures within each portion of the project. Similarly, a subcontract between the GC and subcontractor may describe the work that the subcontractor will perform for the construction project, along with the associated cost codes for the project, as well as an amount that the GC will pay the subcontractor for their work.

During the course of construction, subcontractors typically issue invoices to the GC for work they have provided during a given billing period. The GC, in turn, may invoice the owner for payment that includes the corresponding amounts due to the various subcontractors. Given that a construction project may involve dozens, if not hundreds of subcontractors, the process for a GC to create owner invoices can be extremely cumbersome.

Accordingly, having an effective and efficient project management system in place is important for any organization trying to manage contractual obligations in a complex construction project.

### OVERVIEW

A prime contract between an owner and a GC can take a number of different forms. One of the most common is a guaranteed maximum price (“GMP”), also known as a “cost plus” or “not-to-exceed” contract, in which the owner pays the GC for the actual costs the GC incurs during the construction project, plus a fixed fee, all of which is subject to a maximum price. The SOV associated with a GMP contract can be quite detailed, including multiple divisions that represent general areas of work that will be done on the construction project (e.g., 01—General Requirements, 02—Site Construction, 03—Concrete, 04—Masonry, etc.). Further, each division (or division code) may include multiple cost codes representing more specific categories of work that will be performed within each division. Cost codes and their parent division codes may collectively be referred to as project codes, although another nomenclature is also possible.

For instance, within the division code 03-Concrete, the SOV of the prime contract (the “prime contract SOV”) may include cost codes such as 03-100—Concrete Reinforcement, 03-210—Cast-In-Place Concrete, 03-230—Anchor Bolts, and so on. Further, each line item of the prime contract SOV may have an associated cost type that indicates the type of cost corresponding to the line item in question. Example cost types include “Labor,” “Materials,” or “Commitment” which may indicate that the GC will obtain a commitment from a subcontract to complete the work. For example, the GC will typically enter subcontracts with numerous subcontractors to complete the work associated with one or more of the individual cost codes. Accordingly, each subcontract may include its own SOV (a “sub SOV”) that includes one or more line items matching up to a cost code and cost type from the prime contract SOV.

For each billing period during the project (e.g., monthly), the GC will receive invoices from its subcontractors (“sub invoices”) for the work that each subcontractor performed during that period, with each sub invoice listing the relevant project code, typically at the cost code level of detail. After reviewing and approving each sub invoice, the GC may then prepare a corresponding owner invoice that matches up the line item costs that the GC incurred, by cost code, to the associated cost codes in the prime contract SOV. With a large number of sub invoices, this process can be quite time consuming and difficult to manage.

Another common type of prime contract is a lump-sum, or fixed-price contract. Unlike a GMP contract, under a lump-sum contract, the owner and GC agree in advance on the fees that the GC will be paid for each portion of the project. These lump-sum fees include both the GC's costs as well as its profits. The prime contract SOV associated with a lump-sum contract is typically far less detailed than that of a GMP contract and may only include line items having project codes detailed at the division level, without drilling down on specific cost codes in each division. Nonetheless, a GC's subcontracts will typically still include a sub SOV detailing the specific cost code(s) for which a subcontractor is responsible, as above, as this may assist the GC in managing its own subcontracts, costs, and obligations during the construction project.

Although the owner does not pay the GC's actual costs under a lump-sum contract, it may still be desirable for the GC to invoice the owner an amount that is approximately equal to the invoices the GC received, and is obligated to pay, during a given period. Thus, the GC may include all approved sub invoices received during a billing period, as discussed above, in preparation of the owner invoice. However, the line item costs in each sub invoice will be associated with cost codes that are not present in the prime contract SOV, which includes only line items with a parent-level (i.e., division-level) project code.

Thus, the GC must determine, for each cost code in its sub invoices, the corresponding division code. For example, the cost code 03-100—Concrete Reinforcement corresponds to the division code 03—Concrete. The GC can then match each sub invoice line item to the corresponding division codes that appear in the prime contract SOV and prepare an owner invoice that aggregates the sub invoice costs within each respective division. In some cases, the GC may also include a markup of its costs to represent a portion of its profits that were built into the lump-sum contract. As with a GMP contract discussed above, the process of owner invoicing under a lump-sum contract can be very time consuming and cumbersome.

Further, under either type of prime contract, a construction project may also include additional contractual obligations in the way of change orders, which typically represent changes in project scope after the initial contract is agreed to. Change orders, once approved, may introduce new project codes to the prime contract SOV, change the costs associated with existing project codes, and/or introduce new subcontractors and new sub invoices. This may require even further coordination and diligence on the part of the GC to match sub invoice costs with the correct line items in the prime contract.

To address these and other problems associated with the numerous contractual responsibilities that may be associated with a construction project, disclosed herein is an improved software application that enables users to track and manage multiple layers and different types of contractual responsibilities among the parties involved, and to more easily generate owner invoices based on those contractual responsibilities. In this respect, the disclosed software application provides a flexible solution that allows users to manage projects in a more effective manner.

At a high level, the disclosed software application enables a GC (or other construction manager, project manager, etc.) to generate prefilled owner invoices that automatically match incoming costs from subcontractor invoices and other sources to the corresponding line items in a prime contract SOV, regardless of the format of the prime contract and inclusive of any approved change orders. This may facilitate the efficient preparation of owner invoices that is greatly improved over previous methods.

The processes discussed herein may involve querying all line items from approved sub invoices that fall into a selected period, and then indexing each sub invoice line item into an index table a plurality of times. For example, the indexing may involve adding each sub invoice line item to the index table a first time according to its associated cost code and cost type, and then a second time according to its associated division code, which the software application may derive from the cost code. After the index table is populated, the software application may, for each line item in the prime contract SOV, find all matching line items in the index table. Although each line item from the sub invoices is repeated in the index table due to the multiple indexing, each line item will only be matched to the prime contract SOV once based on the type of project code used in the prime contract SOV—division codes (e.g., a lump-sum contract) or cost codes (e.g., a GMP contract). Each of these processes, which may take various forms and may be carried out in various manners, are described in further detail below.

Accordingly, in one aspect, disclosed herein is a method that involves (1) receiving, via a first client station associated with a first user, a prime contract schedule of values (SOV), where the prime contract SOV includes a plurality of line items, each line item in the prime contract SOV having an associated project code and contract amount; (2) receiving, via a second client station associated with a second user, one or more sub invoices, where each sub invoice includes at least one sub invoice line item, each sub invoice line item having an associated cost code and sub invoice amount; (3) matching the cost code from each sub invoice line item to a corresponding project code in one of the plurality of line items in the prime contract SOV such that each sub invoice line item corresponds to one of the plurality of line items in the prime contract SOV; (4) based on the matching, generating a prefilled owner invoice such that the sub invoice amount from each respective sub invoice line item is applied to the contract amount from the corresponding line item in the prime contract SOV; and (5) causing a third client station associated with a third user to display the prefilled owner invoice.

In another aspect, disclosed herein is a computing system that includes a network interface, at least one processor, a non-transitory computer-readable medium, and program instructions stored on the non-transitory computer-readable medium that are executable by the at least one processor to cause the computing system to carry out the functions disclosed herein, including but not limited to the functions of the foregoing method.

In yet another aspect, disclosed herein is a non-transitory computer-readable storage medium provisioned with software that is executable to cause a computing system to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 depicts an example network configuration in which example embodiments may be implemented.

FIG. 2 depicts an example computing platform that may be configured to carry out one or more of the functions of the present disclosure.

FIG. 3A depicts an example view of a front-end module for displaying a prime contract SOV that may be presented to a client station.

FIG. 3B depicts another example view of a front-end module for displaying a prime contract SOV that may be presented to a client station.

FIG. 4 depicts an example view of a front-end module for displaying a subcontract SOV that may be presented to a client station.

FIG. 5A depicts an example view of a front-end module for creating a sub invoice that may be presented to a client station.

FIG. 5B depicts an example view of a front-end module for creating a direct cost invoice that may be presented to a client station.

FIG. 6 depicts an example view of a front-end module for reviewing and approving a sub invoice that may be presented to a client station.

FIG. 7 depicts an example invoice line item index table.

FIG. 8A depicts an example view of a front-end module for generating a prefilled owner invoice that may be presented to a client station.

FIG. 8B depicts another example view of a front-end module for generating a prefilled owner invoice that may be presented to a client station.

FIG. 9 depicts an example view of a modal window for reviewing line item totals that may be presented in the front-end module shown in FIG. 8B.

FIG. 10 depicts an example flow chart that may be carried out to facilitate the task of generating prefilled owner invoices.

### DETAILED DESCRIPTION

The following disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

### I. EXAMPLE SYSTEM CONFIGURATION

As described above, the present disclosure is generally directed to an improved software application that enables users to track and manage the contractual obligations involved in a construction project such that the given project can be managed in a more effective manner. For instance, the disclosed software application may enable a GC to generate prefilled owner invoices that match incoming costs from subcontractor invoices and other sources to the corresponding line items in a prime contract SOV, regardless of the format of the prime contract and inclusive of any approved change orders. This, in turn, may facilitate management and execution of the given project in a more efficient and convenient manner.

At a high level, the disclosed software application may comprise front-end software running on client stations of individuals involved in creating the contractual obligations associated with a construction project, and back-end software running on a back-end platform (sometimes referred to as a “cloud” platform) that interacts with and/or drives the front-end software, which may be operated (either directly or indirectly) by the provider of the software. In this respect, the front-end software may take the form of a native application, a web application, and/or a hybrid application, among other possibilities. However, the software technology disclosed herein may take other forms as well.

While running on a user's client station, the front-end of the disclosed software application may provide a user interface through which the user may interact with the software application via visual elements, control elements, or the like. Further, the front-end of the disclosed software application may be comprised of one or more discrete software modules, where each respective software module defines a respective “view” of the user interface through which the user may interact with the software application.

In practice, a given view of the user interface provided by the front-end of the disclosed software application may include one or more “windows,” which may display information and/or present control elements within a certain area of the view. A window can take various forms, and in particular, a window can be manipulated by a user to take various forms. For instance, a user may manipulate a window by hiding (i.e., minimizing or closing) the window, adjusting the window to a different size, and/or moving the window to a different area within a view (e.g., place it next to another window, place it in front of or behind another window, etc.). A window can be manipulated to take various other forms as well.

Further, in practice, a given view of the user interface provided by the front-end of the disclosed software application may include a “menu” that allows a user to select an option to execute a given command (e.g., a command to navigate to another software module of the disclosed software application's front-end). Such a menu may take various forms. As one possibility, a menu may take the form of a “menu bar” that is displayed horizontally across the top of a view and/or along the top of one of more windows within a view. As another possibility, a menu may take the form of a “pull-down menu” that includes a list of options to execute a given command. As yet another possibility, the menu may take the form of a menu bar that includes a pull-down menu, among other control elements, such as one or more filters and/or individual icons that can be selected by an individual to execute a given command. The menu may take various other forms as well.

The user interface of the disclosed software application's front-end may take various other forms as well.

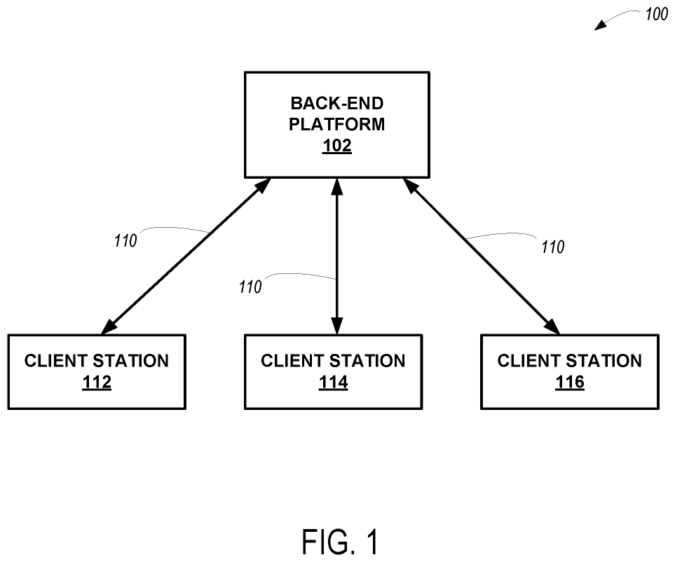

Turning now to the figures, FIG. 1 depicts an example network configuration 100 in which example embodiments of the present disclosure may be implemented. As shown in FIG. 1, network configuration 100 includes a back-end platform 102 that may be communicatively coupled to one or more client stations, depicted here, for the sake of discussion, as three client stations 112, 114, and 116.

In general, back-end platform 102 may comprise one or more computing systems that have been provisioned with software for carrying out one or more of the platform functions disclosed herein, including but not limited to functions related to the disclosed process of generating prefilled owner invoices that match incoming costs from subcontractor invoices and other sources to the corresponding line items in a prime contract SOV. The one or more computing systems of back-end platform 102 may take various forms and be arranged in various manners.

For instance, as one possibility, back-end platform 102 may comprise computing infrastructure of a public, private, and/or hybrid cloud (e.g., computing and/or storage clusters) that has been provisioned with software for carrying out one or more of the platform functions disclosed herein. In this respect, the entity that owns and operates back-end platform 102 may either supply its own cloud infrastructure or may obtain the cloud infrastructure from a third-party provider of “on demand” computing resources, such include Amazon Web Services (AWS) or the like. As another possibility, back-end platform 102 may comprise one or more dedicated servers that have been provisioned with software for carrying out one or more of the platform functions disclosed herein. Other implementations of back-end platform 102 are possible as well.

In turn, client stations 112, 114, 116 may take any of various forms, examples of which may include a desktop computer, a laptop, a netbook, a tablet, a smartphone, and/or a personal digital assistant (PDA), among other possibilities.

As further depicted in FIG. 1, back-end platform 102 is configured to interact with one or more client stations 112, 114, 116 over respective communication paths 110. Each communication path 110 between back-end platform 102 and one of client stations 112, 114, 116 may generally comprise one or more communication networks and/or communications links, which may take any of various forms. For instance, each respective communication path 110 with back-end platform 102 may include any one or more of point-to-point links, Personal Area Networks (PANs), Local-Area Networks (LANs), Wide-Area Networks (WANs) such as the Internet or cellular networks, cloud networks, and/or operational technology (OT) networks, among other possibilities. Further, the communication networks and/or links that make up each respective communication path 110 with back-end platform 102 may be wireless, wired, or some combination thereof, and may carry data according to any of various different communication protocols. Although not shown, the respective communication paths 110 with back-end platform 102 may also include one or more intermediate systems. For example, it is possible that back-end platform 102 may communicate with a given client station 112, 114, 116 via one or more intermediary systems, such as a host server (not shown). Many other configurations are also possible.

Although not shown in FIG. 1, back-end platform 102 may also be configured to receive data from one or more external data sources that may be used to facilitate functions related to the disclosed process of generating prefilled owner invoices. A given external data source and the data output by such data sources may take various forms.

As one example, a given external data source may comprise a database that stores user account information for potential users of the disclosed software application, which may include a potential user's credentials to access different modules of the software application, and back-end platform 102 may be configured to obtain user account information for a potential user from the given data source. As another example, a given external data source may comprise a database that stores data related projects associated with an organization, and back-end platform 102 may be configured to receive such data and cause a client station to present such data. A given external data source may take various other forms as well.

It should be understood that network configuration 100 is one example of a network configuration in which embodiments described herein may be implemented. Numerous other arrangements are possible and contemplated herein. For instance, other network configurations may include additional components not pictured and/or more or less of the pictured components.

### II. EXAMPLE PLATFORM

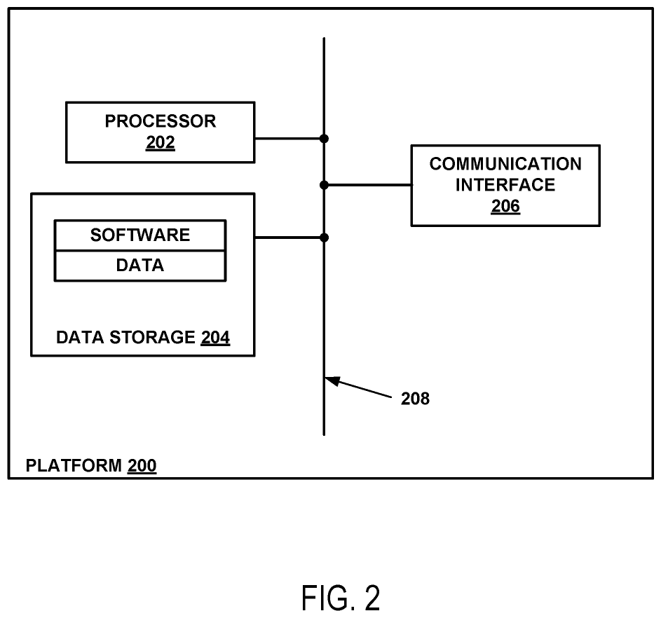

FIG. 2 is a simplified block diagram illustrating some structural components that may be included in an example computing platform 200, which could serve as back-end platform 102 of FIG. 1. In line with the discussion above, platform 200 may generally comprise one or more computer systems (e.g., one or more servers), and these one or more computer systems may collectively include at least a processor 202, data storage 204, and a communication interface 206, all of which may be communicatively linked by a communication link 208 that may take the form of a system bus, a communication network such as a public, private, or hybrid cloud, or some other connection mechanism.

Processor 202 may comprise one or more processor components, such as general-purpose processors (e.g., a single- or multi-core microprocessor), special-purpose processors (e.g., an application-specific integrated circuit or digital-signal processor), programmable logic devices (e.g., a field programmable gate array), controllers (e.g., microcontrollers), and/or any other processor components now known or later developed. In line with the discussion above, it should also be understood that processor 202 could comprise processing components that are distributed across a plurality of physical computing devices connected via a network, such as a computing cluster of a public, private, or hybrid cloud.

In turn, data storage 204 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 204 may comprise computer-readable storage mediums that are distributed across a plurality of physical computing devices connected via a network, such as a storage cluster of a public, private, or hybrid cloud.

As shown in FIG. 2, data storage 204 may be provisioned with software components that enable the platform 200 to carry out the platform-side functions disclosed herein. These software components may generally take the form of program instructions that are executable by the processor 202 to carry out the disclosed functions, which may be arranged together into software applications, virtual machines, software development kits, toolsets, or the like. Further, data storage 204 may be arranged to store data in one or more databases, file systems, or the like. Data storage 204 may take other forms and/or store data in other manners as well.

Communication interface 206 may be configured to facilitate wireless and/or wired communication with external data sources and/or client stations, such as client stations 112, 114, 116 in FIG. 1. Additionally, in an implementation where platform 200 comprises a plurality of physical computing devices connected via a network, communication interface 206 may be configured to facilitate wireless and/or wired communication between these physical computing devices (e.g., between computing and storage clusters in a cloud network). As such, communication interface 206 may take any suitable form for carrying out these functions, examples of which may include an Ethernet interface, a serial bus interface (e.g., Firewire, USB 3.0, etc.), a chipset and antenna adapted to facilitate wireless communication, and/or any other interface that provides for wireless and/or wired communication. Communication interface 206 may also include multiple communication interfaces of different types. Other configurations are possible as well.

Although not shown, platform 200 may additionally include one or more interfaces that provide connectivity with external user-interface equipment (sometimes referred to as “peripherals”), such as a keyboard, a mouse or trackpad, a display screen, a touch-sensitive interface, a stylus, a virtual-reality headset, speakers, etc., which may allow for direct user interaction with platform 200.

It should be understood that platform 200 is one example of a computing platform that may be used with the embodiments described herein. Numerous other arrangements are possible and contemplated herein. For instance, other computing platforms may include additional components not pictured and/or more or less of the pictured components.

### III. EXAMPLE OPERATIONS

As described above, the present disclosure is generally directed to an improved software application that enables users to coordinate and manage contractual obligations within a construction project. In particular, the software application may enable a user, such as a GC, to generate prefilled owner invoices that automatically match incoming costs from subcontractor invoices and other sources to the corresponding line items in a prime contract SOV, regardless of the format of the prime contract.

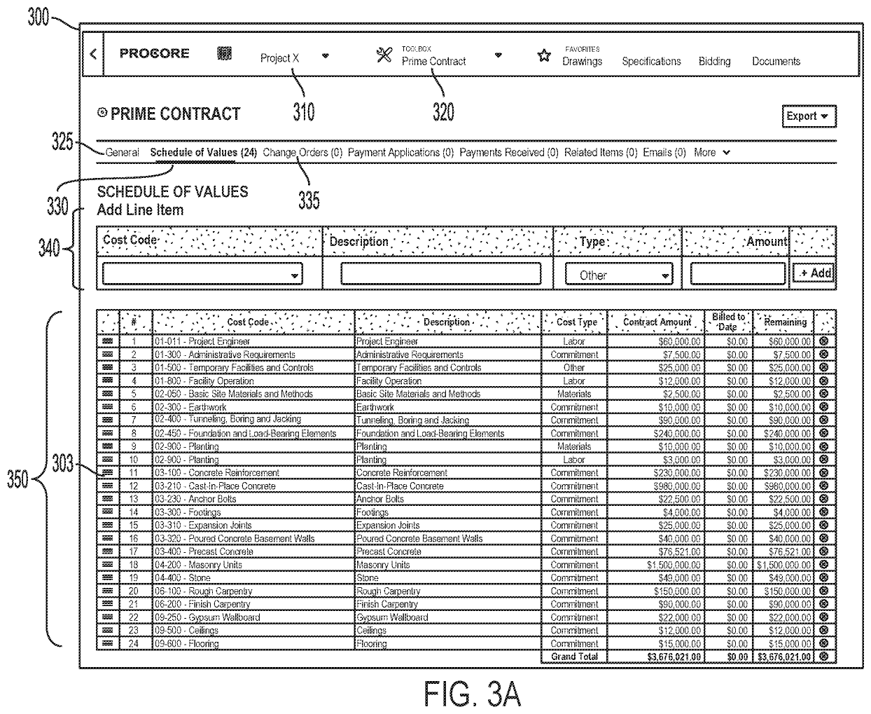

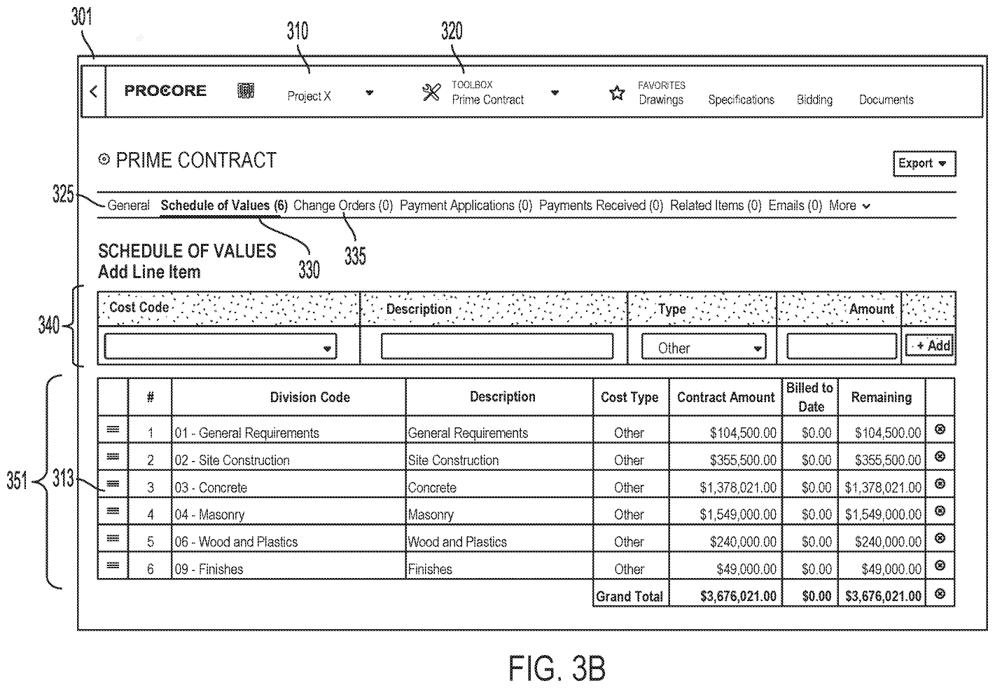

As one example to illustrate, FIG. 3A depicts an example view 300 of a front-end module of the software application discussed herein. The view 300 may be displayed on a first client station corresponding to a first user of the software application. For instance, the first client station may be the client station 112 shown in FIG. 1, and the first user may be the GC overseeing the construction project. The view 300 of the front-end module includes a project indication 310 showing the given construction project that the user is currently managing via the software application. In FIG. 3A, the project indication 310 lists “Project X” as the current project. Further, the project indication 310 may be a selectable indication that allows the first user to select a different project to view and manage. In this way, the software application may be used to manage multiple ongoing construction projects and switch between them relatively easily.

The example view 300 also includes a tool indication 320 showing which tool of the front-end module is currently in use. The tool may be a sub-module with the front-end module that allows the user to perform certain functions within a given aspect of the project. In FIG. 3A, the tool indication 320 lists the “Prime Contract” tool as the current tool. Similar to the project indication 310, the tool indication 320 may be selectable to choose different tools, which may allow the user to manage different aspects of the selected project.

For example, the Prime Contract tool shown in FIG. 3A may allow the GC to input data regarding the prime contract between the owner and GC into the software application. This may include general contract details such as the names of the GC and owner, the name of the project, the execution date of the prime contract, expected completion date of the construction project, and so on. In the example view 300 shown in FIG. 3A, such information may be entered and viewed in a “General” tab 325.

Under a “Schedule of Values” tab 330, the GC may enter data related to the SOV of the prime contract, or prime contract SOV. For example, the view 300 shows a region 340 including controls for the GC to manually add line items to the prime contract SOV. As another example, the front-end module may include options for importing data from other sources to populate the prime contract SOV. For instance, the front-end module may include a separate “Budget” tool that allows the GC to build a cost estimate for the construction project at a cost code level, which may be useful as part of a bidding process, for instance. In some implementations, the front-end module may allow the GC to import a previously created cost estimate from the Budget tool to populate the line items of the prime contract SOV. Any modifications might then be made manually. As yet another example, the Prime Contract tool of the front-end module may allow the GC to import data to populate the prime contract SOV from an external source, such as a spreadsheet or CSV file. Other possibilities also exist.

After the data is entered, whatever its source, the prime contract SOV can be viewed in the front-end module, as shown in FIG. 3A. The example view 300 depicts a prime contract SOV 350 listing each of the line items of the prime contract SOV. The prime contract SOV is associated with a GMP-style prime contract between the owner and GC, as the line items are associated with project codes that are broken out as individual cost codes.

FIG. 3B shows another example view 301 of the front-end module discussed above. The view 301 shows most of the same elements discussed above with respect to FIG. 3A. However, the prime contract SOV 351 shown in the view 301 is associated with a lump-sum contract, where the line items are associated with project codes broken out at the division code level. Comparing FIG. 3A and FIG. 3B, it can be seen that they represent two different ways to create a contractual obligation for performing the same scope of work on a construction project. For example, the line item amounts from the prime contract SOV 350 can be merged by cost code, within each respective parent division code, to obtain the same values found in each line item of the prime contract SOV 351. The grand totals of the contract amount in both prime contracts are the same.

The front-end module of the software application shown in FIGS. 3A and 3B may facilitate additional functionality related to a prime contract. For instance, during the course of the construction project, the owner and GC may agree on changes to the original scope of the project. To accommodate such changes, the Prime Contract tool of the front-end module may include a “Change Order” tab 335 that allows the GC to create and/or import change orders, which may be similar to the creation of the prime contract SOV discussed above. In some implementations, change orders may include line items having project codes similar to the line items in the prime contract SOV. Additionally or alternatively, change orders may be classified according to a change order number. Other examples are also possible.

Although the examples thus far have generally referred to a GC utilizing the software application at a first client station 112 to manage contractual obligations associated with a construction project, other users at other client stations are also possible. As discussed above, the data entered at the first client station 112 may be communicated to and synced with a back-end platform, such as the back-end platform 102 shown in FIG. 1. In this way, another user such as the owner may have access to the information via a front-end module on a second client station, such as the client station 114 shown in FIG. 1. This may allow the owner to view the prime contract or other details of the construction project. In some implementations, the owner may use the front-end module and to review and approve owner invoices prepared by the GC, which will be discussed further below. Further, while the GC, owner, and other entities may be referred to herein as singular users for ease of explanation, it will be understood that such entities may include numerous individual users who may utilize the software application via front-end modules operating on dozens of client stations at different locations.

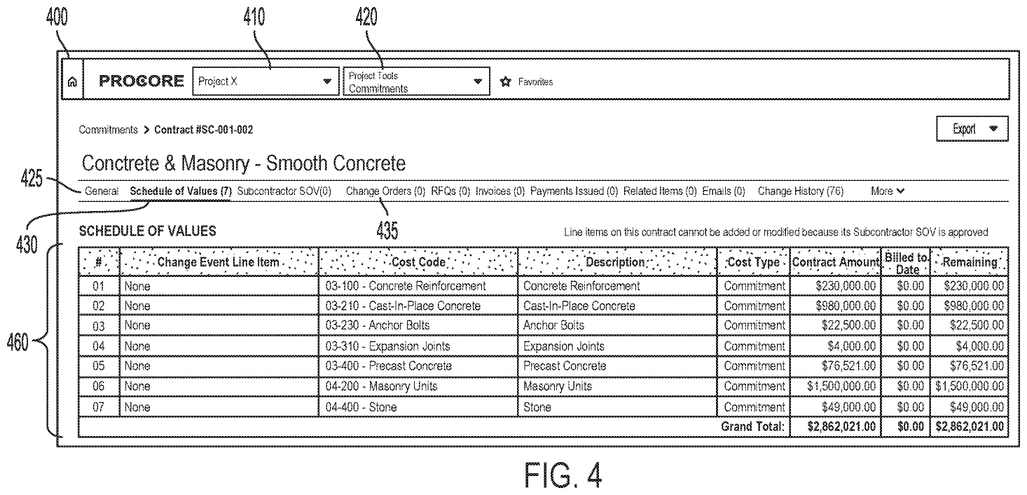

Turning now to FIG. 4, another example view 400 of the front-end module is shown. The view 400 includes a project indication 410 similar to the project indication 310, as well as a tool indication 420. In FIG. 4, the tool indication 420 in the view 400 depicts the “Commitments” tool, which may allow the GC to enter data related to commitments that it makes related to the construction project. As noted above, the GC will not perform many of the tasks associated with the project and will enter into subcontracts with numerous subcontractors to complete respective portions of the project. These subcontracts may be one type of commitment that can be managed via the Commitments tool. For example, the subcontract detailed in FIG. 4 is with a subcontractor called “Smooth Concrete” and is related to concrete and masonry portions of the project. Other types of commitments include purchase orders (“POs”), which may represent a contractual agreement made by the GC for the purchase of good to be used for the construction project, for example.

General information related to a subcontract may be entered in a General tab 425 in the view 400. Similar to a prime contract, a given subcontract may also include a schedule of values, or sub SOV, that the GC may input under tab 430. The sub SOV will typically include line items with associated project codes at the cost code level, as seen in the sub SOV 460 shown in FIG. 4. Each line item in the sub SOV 460 corresponds to a portion of the work that the GC is obligated to complete under the prime contract. In the case of a GMP prime contract, as shown in FIG. 3A, the line items and cost codes in the sub SOV may correspond directly to line items and cost codes in the prime contract SOV. In the case of a lump-sum prime contract, the line items and cost codes in the sub SOV might not correspond directly to the line items in the prime contract SOV, which are only broken down at the division level. Nonetheless, each cost code in the sub SOV, such as 03-100—Concrete Reinforcement, may have a corresponding parent division code in the prime contract SOV, such as 03—Concrete. As with a prime contract, a subcontract may include change orders that can be entered in tab 435.

Comparing FIG. 4 to FIG. 3A, it can be seen that the sub SOV for the subcontract with Smooth Concrete includes line items corresponding to some, but not all, of the line items within division 03—Concrete. Further, the Smooth Concrete sub SOV also includes line items from division 04—Masonry. In addition, there may be other sub SOVs from other subcontracts that overlap and include line items associated with cost codes that are also in the Smooth Concrete sub SOV. For these reasons as well as others, organizing and matching the line items from a plurality of sub SOVs to the corresponding line items from the prime contract SOV can be a cumbersome task.

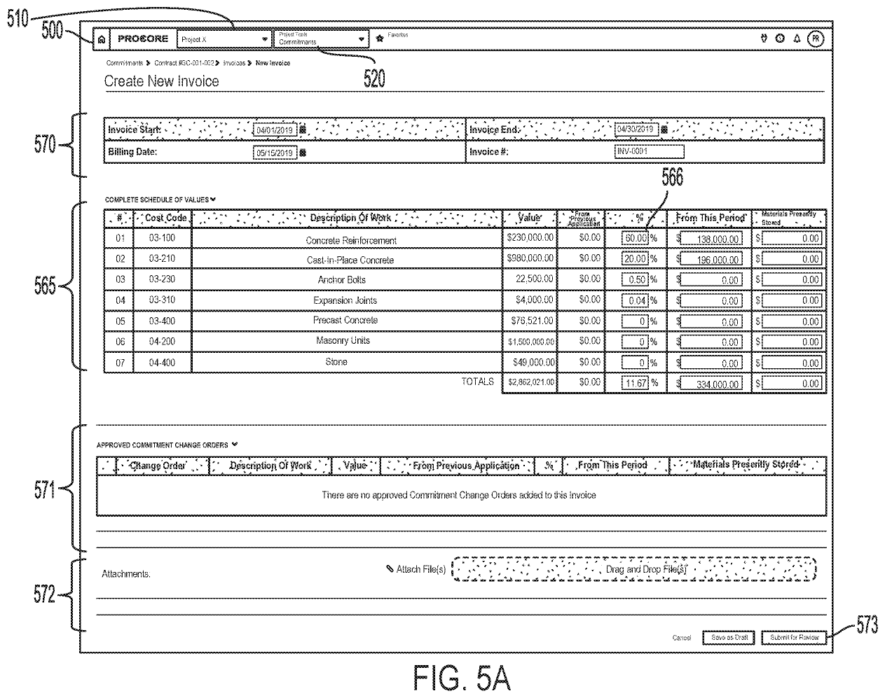

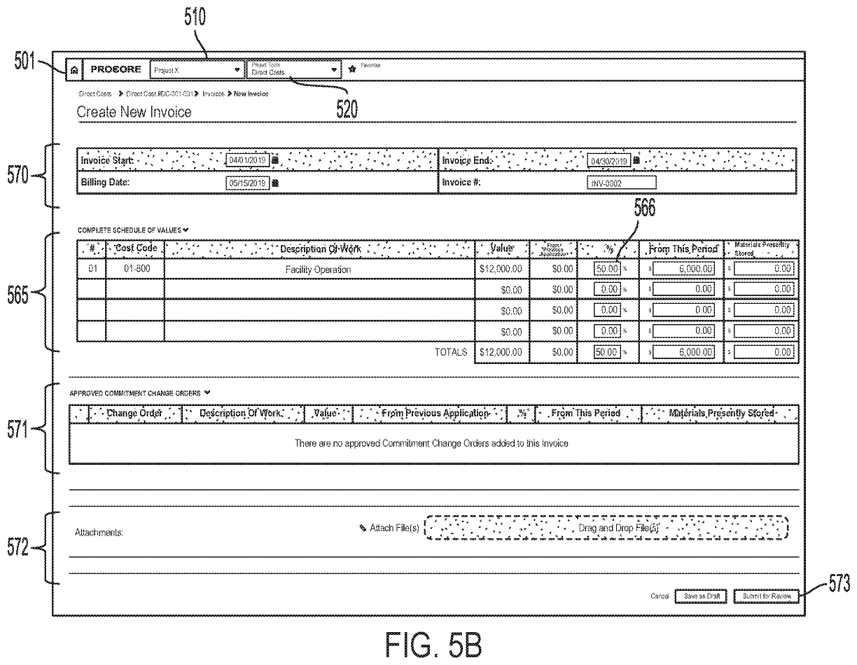

FIG. 5A depicts another example view 500 of the front-end module of the software application, which may be used to create invoices for a given subcontract (a “sub invoice”). For example, a subcontractor, such as Smooth Concrete, may have access to the software application via the front-end module on a third client station, such as the client station 116 shown in FIG. 1. The view 500 includes a project indication 510 and a tool indication 520 as discussed above. The view 500 also includes a sub invoice data region 570 with multiple fields for entering details of the new sub invoice, such as the beginning and end date of the billing period, the date the sub invoice will be issued, an invoice number, and so on. Some or all of this information may be pre-populated based on data from the back-end platform 102, such as a pre-defined billing period established by the GC.

The view 500 also includes a progress entry region 565 within which the subcontractor may assign values to each line item of the sub SOV, representing the amount of work that the subcontractor completed within the billing period. For instance, the subcontractor might enter percentage completion values for one or more line items in the sub SOV. In FIG. 5A, the line item associated with the cost code 03-100—Concrete Reinforcement is indicated as 60% complete in field 566. The invoice values corresponding to each of these completion percentages are also indicated in each line item and are totaled at the bottom of the progress entry region 565.

The view 500 also includes a change order region 571 where line items from any approved change orders to the subcontract may appear. The change order region 571, when populated, may resemble the progress entry region 565, where the subcontractor may enter a completion percentage for the line items of each approved change order. Further, the view 500 includes an attachments region 572 where the subcontractor may upload supporting documentation for the sub invoice that is being created. The supporting documentation might include signed change orders, purchase receipts, photos of completed work, and the like. At the bottom of the view 500, the subcontractor may press a submit button 573, which submits the sub invoice for review to the GC. Any supporting documentation uploaded by the subcontractor in the attachments region 572 will be attached to the sub invoice, allowing the GC to conveniently review the sub invoice and supporting documentation together.

On some construction projects, the GC may perform some of the work outlined in the prime contract SOV. Further, the GC may incur other direct expenses, such as material costs, that might fall under the prime contract SOV. Unlike the commitments discussed above (e.g., subcontracts), these expenses may be categorized as direct costs of the GC and recorded via a “Direct Costs” tool within the front-end module. The creation of a direct cost record may be substantially the same as the creation of a subcontract as discussed above and generally shown in FIG. 4, including creation of a direct cost SOV that has line items corresponding to the prime contract SOV.

FIG. 5B depicts another example view 501 of the front-end module of the software application. The tool indication 520 shows the Direct Costs tool is in use, but otherwise the view 501 is substantially similar to the view 500 shown in FIG. 5A, and may be used to create an invoice for a given direct cost (a “direct cost invoice”). For example, the GC may perform the labor associated with the cost code 01-800—Facility Operation, which corresponds to one of the line items in the prime contract SOV. As shown in the view 501, the GC has indicated in field 566 that the work is 50% complete, and the corresponding invoice totals are shown in the progress entry region 565. Similar to a sub invoice as shown in FIG. 5A, the GC may attach supporting documentation for the direct cost invoice in the attachments region 572.

After a user creates a new sub invoice or direct cost invoice for review, another user may review and approve it. Each individual user may access the software application via a user account that includes permission levels for taking certain actions. Further, individual users within the same organization, such as different employees of the GC, may have different permission levels. For instance, a subcontractor may have a user account for accessing the software application. The subcontractor user account may have permission levels allowing the subcontractor to create and submit sub invoices for review, and to view (but not edit) the subcontract and sub SOV. However, the subcontractor's user account may not permit the subcontractor to edit or even view the prime contract or prime contract SOV. Numerous other examples and permission levels are also possible for any of the users discussed herein.

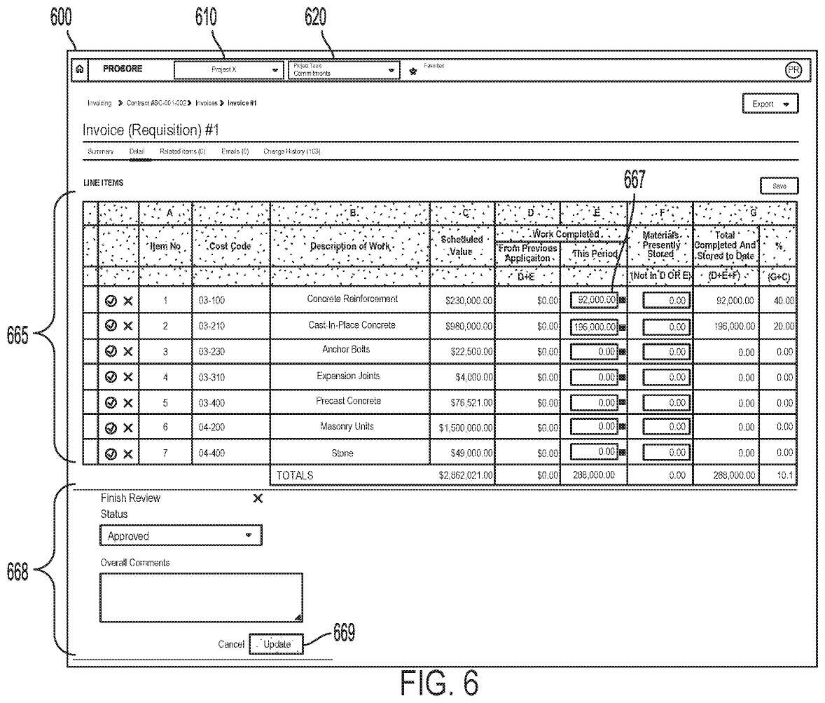

FIG. 6 depicts another example view 600 of the front-end module of the software application, which may be used for reviewing and approving a sub invoice that a subcontractor submitted for review, such as the sub invoice shown in FIG. 5A. For example, a GC user having a user account with the necessary permission levels may review sub invoices that have been submitted, and in some cases, may update them before approving. As shown in FIG. 6, the view 600 includes many of the features discussed above, such as the project indication 610, tool indication 620, and a progress entry region 665 depicting the sub SOV line items and costs codes, along with the completion percentages entered by the subcontractor in the progress entry region 565 shown in FIG. 5A.

As noted above, the GC user reviewing the sub invoice may update the values entered by the subcontractor. For example, as shown in FIG. 6, the GC user has updated field 667 to indicate that the work associated with cost code 03-100—Concrete Reinforcement is only 40% complete, rather than the 60% value entered by the subcontractor, as seen in FIG. 5A. The invoice amount is updated accordingly, along with the totals for the sub invoice. The view 600 also includes an update status region 668, where the GC may indicate the status of the sub invoice (e.g., Pending Approval, Approved, Rejected, etc.), input any comments, and then finalize any changes by selecting an “Update” button 669. Other configurations of the view 600 are also possible.

During a given billing period (e.g., monthly), the GC may receive and approve a substantial number of sub invoices from multiple different subcontractors, depending on the size and scope of the construction project. Further, the GC may incur costs from other commitments, such as POs, as well as direct costs for portions of the project the GC is handling directly. It may then be desirable for the GC invoice the owner in such a way that applies each of the costs that the GC incurred to the corresponding line items from the prime contract SOV. However, as noted above, tracking each of these costs and correctly applying them can be challenging, particularly when the format of the prime contract SOV may be different from one project to the next.

To address these challenges, the software application discussed herein may implement a flexible solution that can match line items from a sub invoice to the corresponding line item in a given prime contract SOV, regardless of the format of the prime contract SOV. The software application may accomplish this by indexing, via the back-end platform 102, each line item from each sub invoice a plurality of times, each time based on one or more distinct classifications. Thus, the back-end platform 102 may generate an index table that includes a representation of each sub invoice line item a plurality of times.

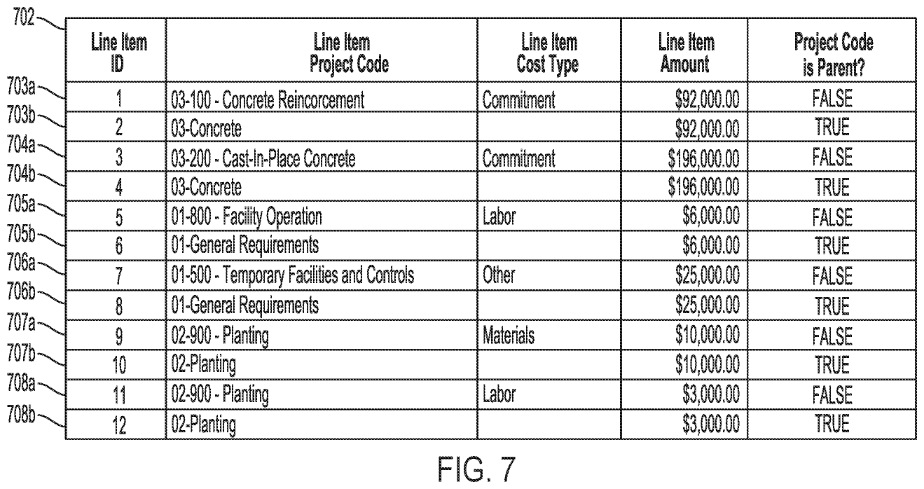

FIG. 7 depicts an example index table 702 that the back-end platform 102 might generate in this way, based on some of the examples discussed herein. In some implementations, the back-end platform 102 might generate the index table 702 in response to a GC request to create an owner invoice via the front-end module. For example, the GC may indicate a billing period for the owner invoice that is to be created. The back-end platform 102 may identify all approved commitment invoices (e.g., sub invoices) and direct costs that were received within that billing period, and then generate the index table based on them.

For instance, within the indicated billing period, the GC might receive the concrete and masonry sub invoice shown in FIG. 5A, and may further update the sub invoice before approval, as shown in FIG. 6 and discussed above. To generate the index table, the back-end platform 102 may index each line item from the approved sub invoice a first time based on its associated cost code and cost type. As seen in FIG. 7, line item 703a in the index table 702 depicts the first indexing of the first line item shown in FIG. 6, listing the associated the cost code (03-100—Concrete Reinforcement), cost type (Commitment), and sub invoice amount. Similarly, line item 704a in the index table 702 depicts the first indexing of the second line item shown in FIG. 6, listing the associated cost code (03-200—Cast-In-Place Concrete), cost type (Commitment), and sub invoice amount.

As discussed above, the sub invoice cost codes may not be the same as a prime contract SOV that has project codes that are is categorized at the division code level. For this reason, the back-end platform 102 may determine the parent division code for each sub invoice line item based on its associated cost code, and then index each sub invoice line item a second time based on its determined division code. Accordingly, line item 703b in the index table 702 depicts the second indexing of the first line item shown in FIG. 6, listing the determined division code (03—Concrete) and sub invoice amount. In a similar way, line item 704b in the index table 702 depicts the second indexing of the second line item shown in FIG. 6, listing the same parent division code (03—Concrete), even though the first and second sub invoice line items have different cost codes. Further, line item 704b lists the sub invoice amount corresponding to the second line item shown in FIG. 6.

Within the indicated billing period, the GC may also incur the direct cost for facility operation discussed above in relation to FIG. 5B. Accordingly, the back-end platform 102 may index the direct cost invoice a first time, shown at line item 705a in the index table 702, and a second time, as shown at line item 705b. Further, the GC may receive an invoice for other types of commitments, such as a PO invoice related to the cost code 01-500—Temporary Facilities and Controls. The line item from this PO invoice may be indexed twice as shown in the index table at line items 706a and 706b.

Finally, to complete the example shown in FIG. 7, the GC may receive two additional sub invoices during the billing period, from different subcontractors, that each include a line item associated with the same cost code, but a different cost type. For example, line item 707a of the index table 702 depicts the first indexing of the sub invoice line item associated with cost code 02-900—Planting and the cost type of “Materials.” Similarly, line item 708a shows the first indexing of the sub invoice line item associated with same cost code 02-900—Planting, but a different cost type of “Labor.” As above, the second indexing of these two line items is shown at line items 707b and 708b, respectively, of the index table 702.

Comparing the sub invoice amount of each line in the index table 702, the multiple indexing discussed above is apparent, as each sub invoice amount is repeated from the first indexing to the second. Further, the index table 702 may include a column (e.g., the last column shown in FIG. 7) that indicates whether the project code listed on each line of the index table 702 is a parent (i.e., it is a division code), or not (i.e., it is a cost code).

In some implementations, the project codes for a construction project may be expressed in a syntax similar to those discussed above, including a numerical code followed by a short text-based description. For instance, a division code may be expressed in a first syntax including a two-digit numerical code following by a short text description of the category of work to be performed. A cost code may be expressed in a second syntax that includes the numerical portion of its parent division code followed by a three-digit numerical sub-code, and then a short text description of the work to be performed. In some other examples, the project codes discussed herein may be expressed by their numerical syntax only, without the text-based description. Numerous other examples of project code syntaxes and formats are also possible.

Once the index table 702 is generated, the back-end platform 102 may match the cost codes from each sub invoice line item to the project codes in the prime contract SOV, and based on this matching, generate the owner invoice. This matching may proceed whether the project codes in the prime contract SOV are expressed as division codes or cost codes. Further, the back-end platform 102 will match each sub invoice line item to the prime contract SOV once, even though each sub invoice line item appears in the index table 702 more than once.

For example, the back-end platform 102 may query each line item in the prime contract SOV and determine, for each line item, whether the associated project code is a division code. This may be determined, for instance, based on the syntax of the project code. If the project code is not a division code (i.e., it is a cost code), the back-end platform 102 may return all matching lines form the index table 702 that have the same project code (i.e., cost code) and cost type. Using the prime contract SOV 350 shown in FIG. 3A as an example, the back-end platform 102 may determine that the project code associated with each line item of the prime contract SOV 350 is a cost code. Accordingly, for each line of the prime contract SOV 350, the back-end platform will return line items from the index table 702 that match both the cost code and cost type in the prime contract SOV 350, which will then be included in the owner invoice.

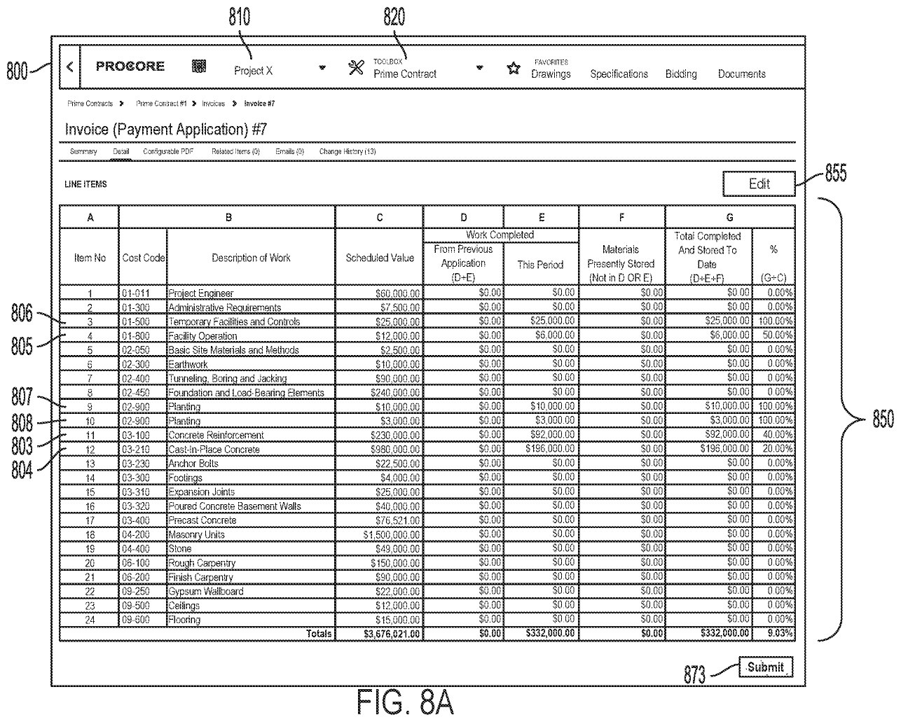

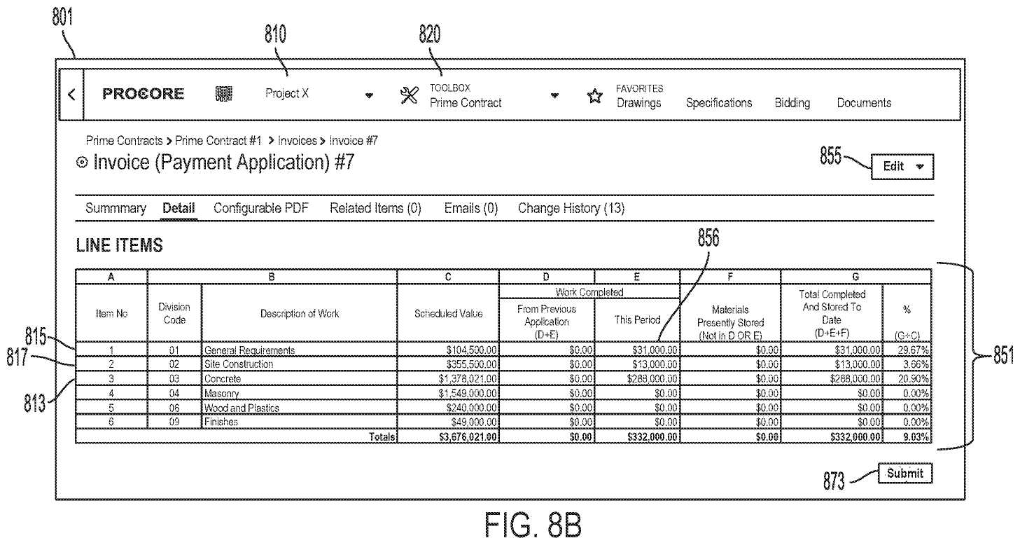

To illustrate, FIG. 8A depicts an example view 800 of the front-end module that may be presented to a client station, including a project indication 810 and tool indication 820 as discussed above. The view 800 also shows a prefilled owner invoice 850 generated by the back-end platform 102, according to the preceding examples. For instance, the back-end platform 102 may query line 303 from the prime contract SOV 350. After determining that the associated project code is a cost code (03-100—Concrete Reinforcement), the back-end platform 102 may return line item 703a from the index table 702 because it matches both the cost code and cost type (Commitment) found in line 303. Thus, the resulting line item 803 in the prefilled owner invoice 850 includes the sub invoice amount that corresponds to the approved invoice shown in FIG. 6.

The back-end platform 102 may follow the same process for each line item in the prime contract SOV 350 such that line items 804, 805, 806, 807, and 808 in the prefilled owner invoice 850 are all populated with the matching line items from the index table 702, as shown in FIG. 8A. For the other line items in the prime contract SOV 350, for which no commitment invoices or direct costs were received during the billing period, there are no matches in the index table 702. Thus, the invoice amount for these line items in the prefilled owner invoice is zero. The view 800 also includes a button 855 that the GC may press in order to make edits to the prefilled owner invoice 850, as well as a button 873 that the GC may press to finalize and submit the prefilled owner invoice to the owner for review. The owner may then view the prefilled owner invoice on the client station 116, for example.

In some implementations, the back-end platform 102 may, as part of generating the prefilled owner invoice, attach the commitment and direct cost invoices on which the prefilled owner invoice is based, as well as the supporting documentation discussed above. For example, each sub invoice and direct cost invoice received in the billing period, and which contributed to the index table 702, may be attached to the prefilled owner invoice. Further, any signed change orders, purchase receipts, photos of completed work, etc., that were attached to a sub invoice by a subcontractor or attached to a direct cost invoice by the GC may also be attached to the prefilled owner invoice. This may allow the owner to conveniently receive and review the prefilled owner invoice with all supporting documentation compiled in a single location. Moreover, this may save the GC a substantial amount of time that might otherwise be spent collating this information.

In the examples discussed herein, the index table 702 only includes one line item for a given cost code and cost type pair. However, in some implementations, the GC might receive multiple commitment invoices and/or direct costs during a billing period that are associated with the same cost code and cost type pair. This would result in the back-end platform 102 returning more than one line item from the index table that matches the cost code and cost type from a given line item of the prime contract SOV. In these situations, all returned line items would be summed and then added to the prefilled owner invoice for the given prime contract SOV line item.

Returning now to the matching process discussed above, after querying a line item from the prime contract SOV, the back-end platform 102 may determine that the associated project code is a division code. In this situation, the back-end platform 102 may return all matching lines from the index table 702 that have the same project code (i.e., division code). Using the prime contract SOV 351 shown in FIG. 3B as an example, the back-end platform 102 may determine that the project code associated with each line item of the prime contract SOV 351 is a division code. Accordingly, for each line of the prime contract SOV 351, the back-end platform 102 will return line items from the index table 702 that match the division code in the prime contract SOV 351, which will then be included in the owner invoice.

To illustrate, FIG. 8B depicts an example view 801 of the front-end module that may be presented to a client station, including a project indication 810 and tool indication 820 as discussed above. The view 801 also shows a prefilled owner invoice 851 generated by the back-end platform 102. For instance, the back-end platform 102 may query line item 313 from the prime contract SOV 351. After determining that the associated project code is a division code (03—Concrete), the back-end platform 102 may return line items 703b and 704b from the index table 702 because they both match the project code found in line item 313 from the prime contract SOV 351. The resulting line item 813 in the prefilled owner invoice 851, which is associated with the division code 03—Concrete, includes the summed total of both returned line items from the index table 702.

The back-end platform 102 may follow the same process for each line item in the prime contract SOV 351 such that line items 815 and 817 in the prefilled owner invoice 851 are populated with the matching line items from the index table 702, as shown in FIG. 8B. As above, the line items from the prime contract SOV 351 for which there were no matching line items in the index table 702 have a corresponding line item in the prefilled owner invoice 851 with an invoice amount of zero. Similar to the view 800 shown in FIG. 8A, the view 801 includes a button 855 that the GC may press in order to make edits to the prefilled owner invoice 851, and a button 873 that the GC may press to finalize and submit the prefilled owner invoice 851 to the owner for review.

As can be seen from the example above, even though one or more sub invoices contain line items with associated project codes broken out at the cost code level, as shown in FIG. 6, the back-end platform 102 will aggregate each line item into its respective parent division codes when the prime contract SOV is set up at the division code level. In this way, the back-end platform 102 may match the cost codes from each sub invoice line item to a corresponding project code in one of the plurality of line items in the prime contract SOV such that each sub invoice line item corresponds to one of the plurality of line items in the prime contract SOV.

In some implementations, the prefilled owner invoice 851 shown in the view 801 may include selectable links that may provide a user with additional information, if selected. For example, the displayed invoice amount 856 shown in FIG. 8B may be selectable to display supporting details for the displayed line item total 856, provided the user has a user account with the necessary permissions to view such information.

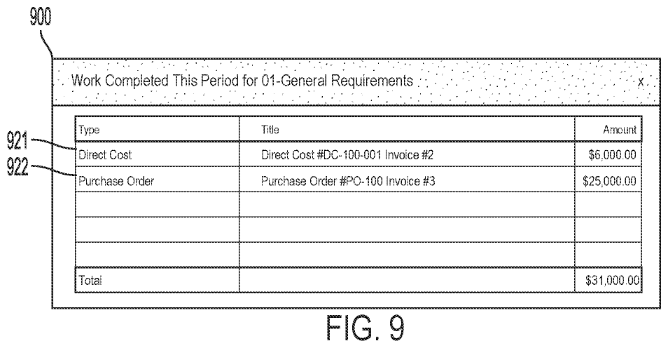

For instance, FIG. 9 shown depicts an example view 900 of a modal or similar window that may be presented in the front-end module shown in FIG. 8B. The view 900 displays information regarding the source(s) of the displayed invoice amount 856, which represents the total amount being invoiced for the division code 01—General Requirements. In particular, the view 900 displays two line items, each associated with a source that contributed to the displayed invoice amount 856. The first line item 921 is associated with the direct cost invoice discussed above in relation to FIG. 5B and indexed at line items 705a and 705b of the index table 702. The second line item 922 is associated with the PO invoice indexed at line items 706a and 706b of the index table 702. In some implementations, these displayed sources may include further selectable links that may allow a user for drill down into the details of one or both of these invoices even further.

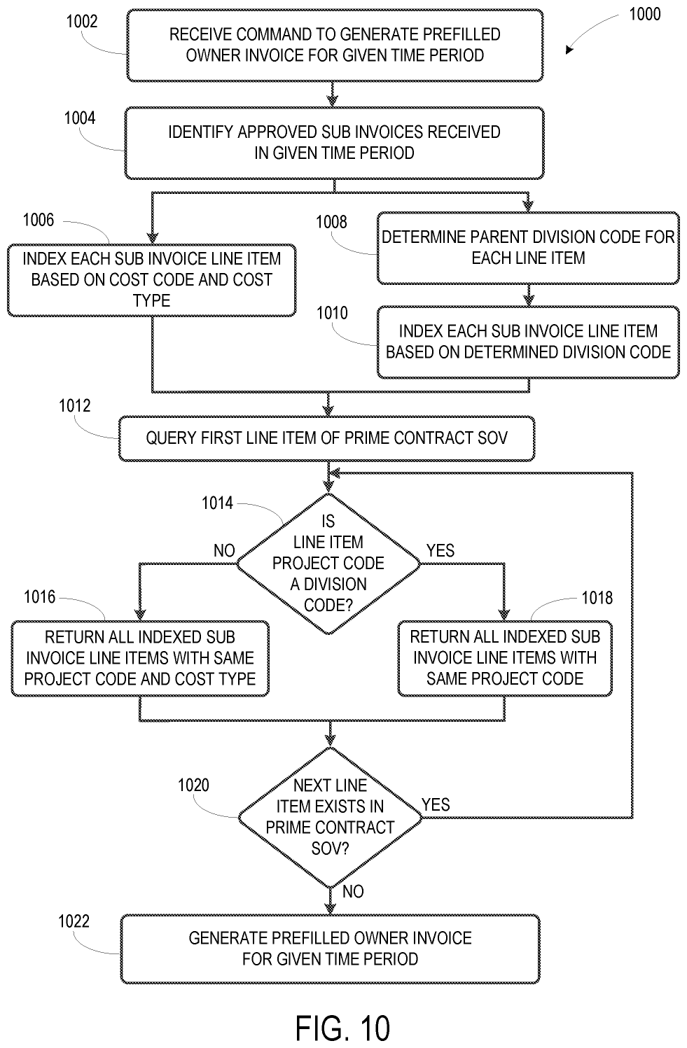

Turning now to FIG. 10, an example flow chart 1000 is displayed that may be carried out to facilitate the task of generating prefilled owner invoices. In the examples herein, for the purposes of illustration only, the functions in the flow chart 1000 are described as being carried out by a back-end platform of a software application, such as the back-end platform 102 shown in FIG. 1. However, it is possible that the responsibility for carrying out the functions of the disclosed flow chart 1000 could be distributed between a computing system that includes the back-end platform 102 and one or more client stations (e.g., client stations 112, 114, and/or 116). Further, it should be understood that the flow chart 1000 in FIG. 10 is merely described in such manner for the sake of clarity and explanation and that some functions may be carried out in various other manners as well, including the possibility that example functions may be added, removed, rearranged into different orders, grouped together, and/or not grouped together at all.

At block 1002 of the flow chart 1000, the back-end platform 102 may receive a command to generate a prefilled owner invoice for a given time period. The prefilled owner invoice may correspond to a prime contract SOV that details the contractual obligations between an owner of a construction project and a GC who is managing the project, as discussed above. For example, a GC may input the command to generate the prefilled owner invoice via a front-end module of the software application running on a first client station, such as the client station 112 shown in FIG. 1. The given time period may be manually selected by the GC in conjunction with inputting the command, or the given time period may be automatically assigned as a default billing period. Other examples are also possible.

At block 1004, in response to the received command, the back-end platform 102 may identify all approved sub invoices that were received in the given time period. As discussed above, the back-end platform 102 may also identify other commitment invoices (e.g., POs) and direct cost invoices that were received during the given time period. However, for ease of explanation, the flowchart 1000 and the discussion that follows will refer only to sub invoices.

At block 1006, the back-end platform 102 may index each line item from the identified sub invoices a first time based on the cost code and cost type associated with the line item, as generally discussed above with respect to FIG. 7. At block 1008, the back-end platform 102 may determine a parent division code for each line item. For instance, the parent division code for each line item may be determined based on the cost code for the given sub invoice line item, as noted previously. At block 1010, the back-end platform 102 may index each line item from the identified sub invoices a second time based on the determined division code for each line item. The indexing of the sub invoice line items may result in the creation of an index table, such as the index table 702 shown in FIG. 7 and discussed above.

Although the first and second indexing functions discussed above and shown at blocks 1006-1010 are depicted as occurring in parallel, numerous other possibilities exist. For instance, the first and second indexing functions might be applied to all sub invoice line items in series, with the second indexing being completed at the conclusion of the first. Other examples are also possible.

At block 1012, the back-end platform 102 may query a first line item of the prime contract SOV, and then determine at block 1014 whether the project code associated with the queried line item is a division code or not. If the project code is not a division code (i.e., it is a code code), then at block 1016 the back-end platform 102 will return all indexed sub invoice line items that are associated with the same project code (i.e., cost code) and cost type as the queried line item from the prime contract SOV, as discussed in the examples above.

Alternatively, if the back-end platform 102 determines at block 1014 that the project code associated with the queried line item is a division code, then at block 1018 the back-end platform 102 will return all indexed sub invoice line items that are associated with the same project code (i.e., division code) as the queried line item from the prime contract SOV, as above.

The back-end platform 102 may perform the functions depicted at block 1014-1018 for every line item in the prime contract SOV in order to generate the prefilled owner invoice. For example, after returning the indexed sub invoice line items for a given line item of the prime contract SOV, the back-end platform 102 may, at block 1020, determine whether a next line item exists in the prime contract SOV. If a next line item does exist, the back-end platform 102 returns to block 1014 and determines whether the project code associated with the line item is a division code. On the other hand, if the back-end platform 102 determines that there is not a next line item in the prime contract SOV, then all line items have been queried and the back-end platform 102 proceeds to block 1022.

At block 1022, the back-end platform 102 may generate the prefilled owner invoice based on the line items returned from the index table in blocks 1016 and/or 1018. For example, the prefilled owner invoice may resemble the prefilled owner invoice 850 shown in FIG. 8A, or the prefilled owner invoice 851 shown in FIG. 8B, depending on the format of the prime contract SOV.

Although the examples herein have discussed a prime contract SOV having project codes of a single type, it will be apparent to one of skill in the art that the implementations presented herein would also be effective for a prime contract SOV that includes different types of project codes. For instance, an example prime contract SOV may include some line items associated with division codes, and some line items associated with cost codes. Because the back-end platform 102 may query each line item from the prime contract SOV individually, as generally shown at block 1014 of the flowchart 1000, the back-end platform 102 will return the indexed sub invoice line items corresponding to the appropriate type of project code.

Further, the examples discussed above and illustrated in the accompanying Figures mention two types of project codes—division codes and cost codes. However, these might not be the only possibilities. For instance, a prime contract SOV and/or a sub SOV may break down a given cost code into even more specific “sub cost codes” that further detail the work that will performed. To accommodate this third layer of project codes, the back-end platform 102 may index each line item in the sub SOV a third time, based on its associated sub cost code. Further, when querying each line item from the prime contract SOV to generate the prefilled owner invoice, the back-end platform 102 may determine whether the associated project code is a division code, and if not, whether it is a cost code. If it is not a cost code (i.e., it is a sub cost code), the back-platform 102 may return all indexed sub invoice line items with the same sub cost code. Applying the same logic, the indexing and matching functions discussed herein could be extended to n different project code layers.

### IV. CONCLUSION

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “users” or other entities, this is for purposes of example and explanation only. Claims should not be construed as requiring action by such actors unless explicitly recited in claim language.

1. A computing system comprising:
at least one processor;
a non-transitory computer-readable medium; and
program instructions stored on the non-transitory computer-readable medium that are executable by the at least one processor to cause the computing system to perform functions including:
receiving, via a first client station associated with a first user, a prime contract schedule of values (SOV), wherein the prime contract SOV comprises a plurality of line items, each line item in the prime contract SOV having an associated project code and contract amount;
receiving, via a second client station associated with a second user, one or more sub invoices, wherein each sub invoice comprises at least one sub invoice line item, each sub invoice line item having an associated cost code and sub invoice amount;
matching the cost code from each sub invoice line item to a corresponding project code in one of the plurality of line items in the prime contract SOV such that each sub invoice line item corresponds to one of the plurality of line items in the prime contract SOV;
based on the matching, generating a prefilled owner invoice such that the sub invoice amount from each respective sub invoice line item is applied to the contract amount from the corresponding line item in the prime contract SOV; and
causing a third client station associated with a third user to display the prefilled owner invoice.

2. The computing system of claim 1, wherein the project codes associated with the plurality of line items in the prime contract SOV comprise a first syntax, and wherein the cost codes associated with the at least one sub invoice line item comprise a second syntax different from the first syntax.

3. The computing system of claim 1, wherein each sub invoice line item further comprises an associated cost type, and wherein the computing system further comprising program instructions stored on the non-transitory computer-readable medium that are executable by the at least one processor to cause the computing system to perform functions including:
indexing each sub invoice line item a first time based its associated cost code and associated cost type;
determining a parent division code for each sub invoice line item based on its associated cost code; and
indexing each sub invoice line item a second time based on its determined parent division code.

4. The computing system of claim 3, wherein the project codes associated with the plurality of line items in the prime contract SOV are division codes, and wherein matching the cost code from each sub invoice line item to a corresponding project code in one of the plurality of line items in the prime contract SOV comprises matching the parent division code for each sub invoice line item to an identical division code in one of the plurality of line items in the prime contract SOV.

5. The computing system of claim 3, wherein each line item in the prime contract SOV further comprises an associated cost type, wherein the project codes associated with the plurality of line items in the prime contract SOV are cost codes, and wherein matching the cost code from each sub invoice line item to a corresponding project code in one of the plurality of line items in the prime contract SOV comprises matching both of the cost code and cost type from each sub invoice line item to an identical cost code and cost type in one of the plurality of line items in the prime contract SOV.

6. The computing system of claim 1, further comprising program instructions stored on the non-transitory computer-readable medium that are executable by the at least one processor to cause the computing system to perform functions including:
receiving, via a fourth client station associated with a fourth user, one or more direct cost invoices, wherein each direct cost invoice comprises at least one direct cost invoice line item, each direct cost invoice line item having an associated cost code and direct cost invoice amount; and
matching the cost code from each direct cost invoice line item to a corresponding project code in one of the plurality of line items in the prime contract SOV such that each direct cost invoice line item corresponds to one of the plurality of line items in the prime contract SOV, wherein generating the prefilled owner invoice comprises generating the prefilled owner invoice such that the direct cost invoice amount from each respective direct cost invoice line item is applied to the contract amount from the corresponding line item in the prime contract SOV.

7. The computing system of claim 6, further comprising program instructions stored on the non-transitory computer-readable medium that are executable by the at least one processor to cause the computing system to perform functions including:
receiving, via the first client station associated with the first user, an indication of a time period;
identifying the one or more sub invoices as being received within the time period, wherein matching the cost code from each sub invoice line item to a corresponding project code in one of the plurality of line items in the prime contract SOV comprises matching, for each sub invoice received within the time period, the cost code from each sub invoice line item to a corresponding project code in one of the plurality of line items in the prime contract SOV; and
identifying the one or more direct cost invoices as being received within the time period, wherein matching the cost code from each direct cost invoice line item to a corresponding project code in one of the plurality of line items in the prime contract SOV comprises matching, for each direct cost invoice received within the time period, the cost code from each direct cost invoice line item to a corresponding project code in one of the plurality of line items in the prime contract SOV.

8. The computing system of claim 1, further comprising program instructions stored on the non-transitory computer-readable medium that are executable by the at least one processor to cause the computing system to perform functions including:
after receiving the one or more sub invoices, receiving, from the first client station, an indication of an update to a given one of the one or more sub invoices; and
based on the received indication, updating the given sub invoice.

9. The computing system of claim 1, further comprising program instructions stored on the non-transitory computer-readable medium that are executable by the at least one processor to cause the computing system to perform functions including:
receiving, via the second client station, one or more supporting documents corresponding to the one or more sub invoices, wherein generating the prefilled owner invoice comprises providing (i) the one or more sub invoices, and (ii) the one or more supporting documents corresponding to the one or more sub invoices as attachments to the prefilled owner invoice.

10. A non-transitory computer-readable storage medium, wherein the non-transitory computer-readable storage medium is provisioned with program instructions that are executable to cause a computing system to perform functions including:
receiving, via a first client station associated with a first user, a prime contract schedule of values (SOV), wherein the prime contract SOV comprises a plurality of line items, each line item in the prime contract SOV having an associated project code and contract amount;
receiving, via a second client station associated with a second user, one or more sub invoices, wherein each sub invoice comprises at least one sub invoice line item, each sub invoice line item having an associated cost code and sub invoice amount;
matching the cost code from each sub invoice line item to a corresponding project code in one of the plurality of line items in the prime contract SOV such that each sub invoice line item corresponds to one of the plurality of line items in the prime contract SOV;
based on the matching, generating a prefilled owner invoice such that the sub invoice amount from each respective sub invoice line item is applied to the contract amount from the corresponding line item in the prime contract SOV; and
causing a third client station associated with a third user to display the prefilled owner invoice.

11. The non-transitory computer-readable storage medium of claim 10, wherein the project codes associated with the plurality of line items in the prime contract SOV comprise a first syntax, and wherein the cost codes associated with the at least one sub invoice line item comprise a second syntax different from the first syntax.

12. The non-transitory computer-readable storage medium of claim 10, wherein each sub invoice line item further comprises an associated cost type, and wherein the non-transitory computer-readable medium is also provisioned with program instructions that are executable to cause the computing system to perform functions including:
indexing each sub invoice line item a first time based its associated cost code and associated cost type;
determining a parent division code for each sub invoice line item based on its associated cost code; and
indexing each sub invoice line item a second time based on its determined parent division code.

13. The non-transitory computer-readable storage medium of claim 12, wherein the project codes associated with the plurality of line items in the prime contract SOV are division codes, and wherein matching the cost code from each sub invoice line item to a corresponding project code in one of the plurality of line items in the prime contract SOV comprises matching the parent division code for each sub invoice line item to an identical division code in one of the plurality of line items in the prime contract SOV.

14. The non-transitory computer-readable storage medium of claim 12, wherein each line item in the prime contract SOV further comprises an associated cost type, wherein the project codes associated with the plurality of line items in the prime contract SOV are cost codes, and wherein matching the cost code from each sub invoice line item to a corresponding project code in one of the plurality of line items in the prime contract SOV comprises matching both of the cost code and cost type from each sub invoice line item to an identical cost code and cost type in one of the plurality of line items in the prime contract SOV.

15. The non-transitory computer-readable storage medium of claim 10, wherein the non-transitory computer-readable medium is also provisioned with program instructions that are executable to cause the computing system to perform functions including:
receiving, via a fourth client station associated with a fourth user, one or more direct cost invoices, wherein each direct cost invoice comprises at least one direct cost invoice line item, each direct cost invoice line item having an associated cost code and direct cost invoice amount; and
matching the cost code from each direct cost invoice line item to a corresponding project code in one of the plurality of line items in the prime contract SOV such that each direct cost invoice line item corresponds to one of the plurality of line items in the prime contract SOV, wherein generating the prefilled owner invoice comprises generating the prefilled owner invoice such that the direct cost invoice amount from each respective direct cost invoice line item is applied to the contract amount from the corresponding line item in the prime contract SOV.

16. The non-transitory computer-readable storage medium of claim 15, wherein the non-transitory computer-readable medium is also provisioned with program instructions that are executable to cause the computing system to perform functions including:
receiving, via the first client station associated with the first user, an indication of a time period;
identifying the one or more sub invoices as being received within the time period, wherein matching the cost code from each sub invoice line item to a corresponding project code in one of the plurality of line items in the prime contract SOV comprises matching, for each sub invoice received within the time period, the cost code from each sub invoice line item to a corresponding project code in one of the plurality of line items in the prime contract SOV; and
identifying the one or more direct cost invoices as being received within the time period, wherein matching the cost code from each direct cost invoice line item to a corresponding project code in one of the plurality of line items in the prime contract SOV comprises matching, for each direct cost invoice received within the time period, the cost code from each direct cost invoice line item to a corresponding project code in one of the plurality of line items in the prime contract SOV.

17. The non-transitory computer-readable storage medium of claim 10, wherein the non-transitory computer-readable medium is also provisioned with program instructions that are executable to cause the computing system to perform functions including:
after receiving the one or more sub invoices, receiving, from the first client station, an indication of an update to a given one of the one or more sub invoices; and
based on the received indication, updating the given sub invoice.

18. The non-transitory computer-readable storage medium of claim 10, wherein the non-transitory computer-readable medium is also provisioned with program instructions that are executable to cause the computing system to perform functions including:
receiving, via the second client station, one or more supporting documents corresponding to the one or more sub invoices, wherein generating the prefilled owner invoice comprises providing (i) the one or more sub invoices, and (ii) the one or more supporting documents corresponding to the one or more sub invoices as attachments to the prefilled owner invoice.

19. A method implemented by a computing system, the method comprising:
receiving, via a first client station associated with a first user, a prime contract schedule of values (SOV), wherein the prime contract SOV comprises a plurality of line items, each line item in the prime contract SOV having an associated project code and contract amount;
receiving, via a second client station associated with a second user, one or more sub invoices, wherein each sub invoice comprises at least one sub invoice line item, each sub invoice line item having an associated cost code and sub invoice amount;
matching the cost code from each sub invoice line item to a corresponding project code in one of the plurality of line items in the prime contract SOV such that each sub invoice line item corresponds to one of the plurality of line items in the prime contract SOV;
based on the matching, generating a prefilled owner invoice such that the sub invoice amount from each respective sub invoice line item is applied to the contract amount from the corresponding line item in the prime contract SOV; and
causing a third client station associated with a third user to display the prefilled owner invoice.

20. The method of claim 19, wherein the project codes associated with the plurality of line items in the prime contract SOV comprise a first syntax, and wherein the cost codes associated with the at least one sub invoice line item comprise a second syntax different from the first syntax.
